(19) United States
(12) Patent Application Publication
(10) Pub. No.: US 2026/0141365 A1
(43) Pub. Date: May 21, 2026

(54) CONTENT PROVIDING SYSTEM, CONTENT PROVIDING METHOD, AND INFORMATION STORAGE MEDIUM

(71) Applicant: Rakuten Group, Inc., Tokyo (JP)

(72) Inventor: Kaisei MITSUI, Tokyo (JP)

(21) Appl. No.: 19/372,280

(22) Filed: Oct. 29, 2025

(30) Foreign Application Priority Data
Nov. 18, 2024 (JP) 2024-200867

(51) Int. Cl. G06Q 20/10

(52) U.S. Cl. CPC G06Q 20/10

(57) ABSTRACT

Provided is a content providing system including at least one processor configured to: acquire input information which is input to a generative model configured to generate content to be provided in a service in which a monetarily valuable item is transmitted among a plurality of users; cause the generative model to generate the content based on the input information; and provide the content to at least one of the plurality of users.

### CROSS-REFERENCE TO RELATED APPLICATION

The present application claims priority from the Japanese patent application JP 2024-200867, filed on Nov. 18, 2024, the disclosures of which are incorporated by reference herein.

### BACKGROUND OF THE INVENTION

### 1. Field of the Invention

The present disclosure relates to a content providing system, a content providing method, and an information storage medium.

### 2. Description of the Related Art

Hitherto, there has been known a service for transmitting a monetarily valuable item among a plurality of users. For example, in Japanese Patent Application Laid-open No. 2007-172358, electronic money is described as an example of the monetarily valuable item. In the technology of Japanese Patent Application Laid-open No. 2007-172358, a reception terminal generates reception information including an amount of electronic money to be received from another communication terminal, transmits the reception information to the another communication terminal, and receives transmitted electronic money transmitted from the another communication terminal when the reception information is transmitted, to thereby implement a service for transmitting the electronic money among a plurality of users.

### SUMMARY OF THE INVENTION

However, with the technology of Japanese Patent Application Laid-open No. 2007-172358, the service for transmitting the electronic money among the plurality of users is only provided, and appropriate content corresponding to this service cannot be provided to users. This point also applies to other monetarily valuable items other than the electronic money. With the related-art technology, appropriate content corresponding to the service for transmitting a monetarily valuable item among a plurality of users cannot be provided to users.

One object of the present disclosure is to provide appropriate content corresponding to a service for transmitting a monetarily valuable item among a plurality of users.

According to at least one embodiment of the present disclosure, there is provided a content providing system including at least one processor configured to: acquire input information which is input to a generative model configured to generate content to be provided in a service in which a monetarily valuable item is transmitted among a plurality of users; cause the generative model to generate the content based on the input information; and provide the content to at least one of the plurality of users.

### BRIEF DESCRIPTION OF THE DRAWINGS

FIG. 1 is a diagram for illustrating an example of a hardware configuration of a content providing system.

FIG. 2 is a view for illustrating an example of screens displayed on a user terminal of a remittance source user.

FIG. 3 is a view for illustrating an example of a screen displayed on a user terminal of a remittance destination user.

FIG. 4 is a diagram for illustrating an example of functions implemented in the content providing system.

FIG. 5 is a table for showing an example of a user database.

FIG. 6 is a diagram for illustrating an example of input to and output from a generative model.

FIG. 7 is a flowchart for illustrating an example of processing executed in the content providing system.

FIG. 8 is a diagram for illustrating an example of functions implemented in modification examples of the present disclosure.

FIG. 9 is a diagram for illustrating an example of input to and output from the generative model in Modification Example 1.

FIG. 10 is a diagram for illustrating an example of input to and output from the generative model in Modification Example 2.

FIG. 11 is a diagram for illustrating an example of input to and output from the generative model in Modification Example 3.

FIG. 12 is a view for illustrating an example of an input screen in Modification Example 4.

FIG. 13 is a diagram for illustrating an example of input to and output from the generative model in Modification Example 5.

FIG. 14 is a diagram for illustrating an example of input to and output from the generative model in Modification Example 7.

FIG. 15 is a diagram for illustrating an example of input to and output from the generative model in Modification Example 8.

### DETAILED DESCRIPTION OF THE INVENTION

### 1. Hardware Configuration of Content Providing System

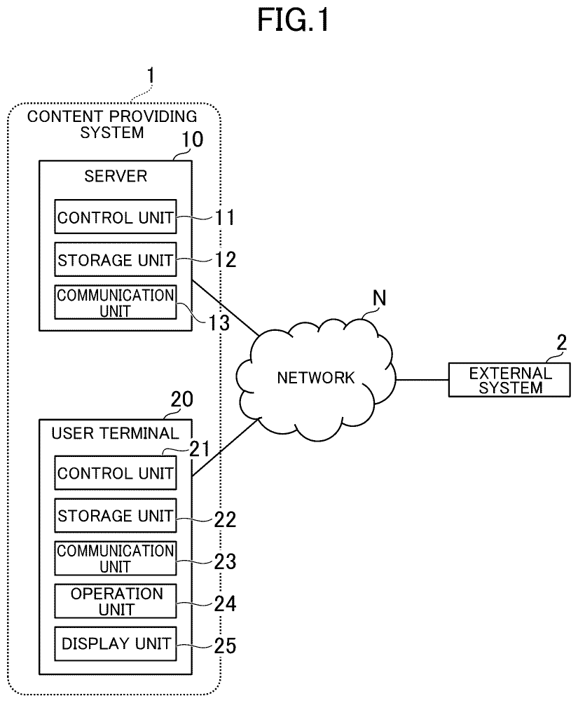

Description is now given of an example of at least one embodiment of a content providing system, a content providing method, and a program according to the present disclosure. FIG. 1 is a diagram for illustrating an example of a hardware configuration of the content providing system. For example, a content providing system 1 includes a server 10 and a user terminal 20. Each of the server 10 and the user terminal 20 is connected to a network N such as the Internet or a LAN. The number of at least one of the servers 10 or the user terminals 20 may be two or more.

The server 10 is a server computer. For example, the server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication.

The user terminal 20 is a computer of a user. For example, the user terminal 20 is a smartphone, a tablet computer, a personal computer, or a wearable terminal. The user terminal 20 includes a control unit 21, a storage unit 22, a communication unit 23, an operation unit 24, and a display unit 25. Hardware configurations of the control unit 21, the storage unit 22, and the communication unit 23 may be the same as those of the control unit 11, the storage unit 12, and the communication unit 13, respectively. The operation unit 24 is an input device such as a touch panel or a mouse. The display unit 25 is a display such as a liquid crystal display or an organic EL display.

Programs stored in the storage units 12 and 22 may be supplied to the server 10 or the user terminal 20 via the network N. Further, the server 10 or the user terminal 20 may include at least one of a reading unit for reading a computer-readable information storage medium (for example, a memory card slot) or an input/output unit (for example, a USB port) through which data is input from or output to an external device. For example, the program stored on the information storage medium may be supplied to the server 10 or the user terminal 20 via at least one of the reading unit or the input/output unit.

Moreover, it is only required for the content providing system 1 to include at least one computer. The computers included in the content providing system 1 are not limited to those of the example of FIG. 1. For example, the content providing system 1 may include only the server 10. In this case, the user terminal 20 exists outside the content providing system 1. The content providing system 1 may include the server 10 and another computer not shown in FIG. 1.

In the at least one embodiment, the content providing system 1 can communicate to and from an external system 2 via the network N. The external system 2 includes at least one server computer. A hardware configuration of the server computer of the external system 2 may be the same as that of the server 10. In the at least one embodiment, there is described a case in which a subject (for example, a business operator which operates a settlement service described later) which manages the server 10 and a subject (for example, a business operator which operates a service of a generative model described later) which manages the server computer of the external system 2 are different from each other, but those subjects may be the same.

### 2. Overview of Content Providing System

In the at least one embodiment, there is exemplified a case in which the content providing system 1 is applied to the settlement service. The settlement service is a service which provides an electronic settlement (cashless settlement) to each of the plurality of users. The user can use any settlement means in the settlement service. For example, the user can use, for the settlement service, electronic money, a balance not called electronic money, a credit card, a card other than a credit card, loyalty points, a bank account, an account other than a bank account, a crypto-asset, a wallet, or other settlement means. The settlement means is used also in payment in some cases, and hence can also be considered as payment means.

In the at least one embodiment, there is exemplified a case in which the user uses the settlement service from a settlement app stored in the user terminal 20. The settlement app is an application provided by the administrator of the settlement service. The user may use the settlement service from another app (for example, an app provided by a card company of a credit card or another app of a non-settlement type) other than the settlement app stored in the user terminal, or may use the settlement service from a browser stored in the user terminal 20. The user may use the settlement service through not the program stored in the user terminal 20, but an IC chip of the user terminal 20.

For example, the settlement service provides a plurality of functions to the user. In the at least one embodiment, there is exemplified, out of the plurality of functions of the settlement service, a remittance function for the user to remit electronic money to another user. The user who remits the electronic money to another user is hereinafter referred to as “remittance source user.” The another user who receives the electronic money from the remittance source user is hereinafter referred to as “remittance destination user.” In FIG. 1, only one user terminal 20 is illustrated, but it is assumed that the user terminal 20 of the remittance source user and the user terminal 20 of the remittance destination user actually exist. When the remittance source user and the remittance destination user are not distinguished from each other, those users are simply referred to as “users.”

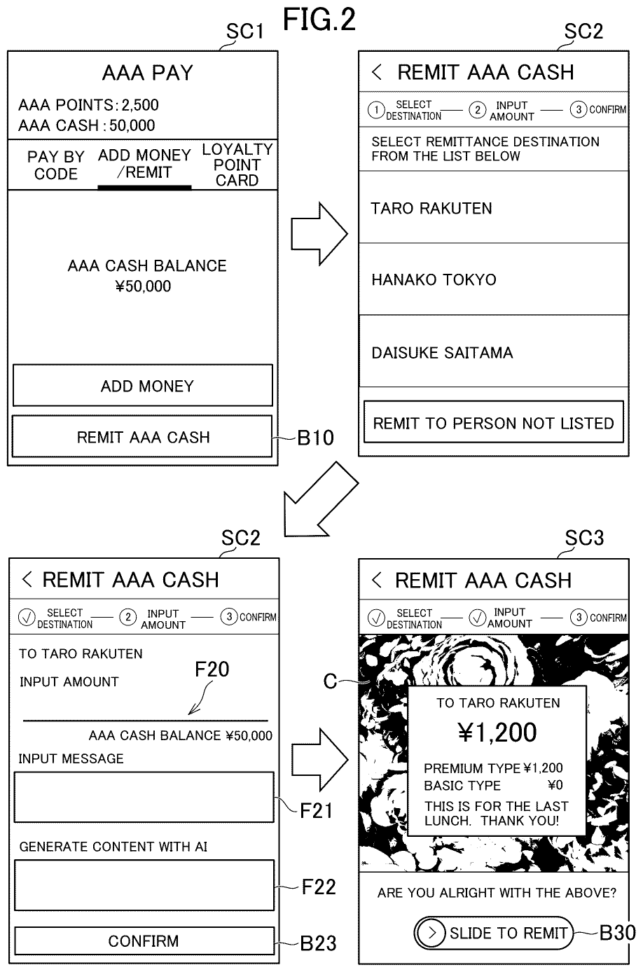

FIG. 2 is a view for illustrating an example of screens displayed on the user terminal 20 of the remittance source user. For example, when the remittance source user operates his or her own user terminal 20 to start the settlement app, the user terminal 20 of the remittance source user displays a top screen SC1 of the settlement app on the display unit 25 as illustrated on the upper left side of FIG. 2. When the remittance source user selects a button B10 for using the remittance function, as illustrated on the upper right side of FIG. 2, the user terminal 20 of the remittance source user displays an input screen SC2 for receiving input of required items in the remittance function on the display unit 25. In the example of the upper right side of FIG. 2, a list of other users being candidates of the remittance destination user is displayed on the input screen SC2.

For example, another user being the candidate of the remittance destination user may be another user registered in a contact book stored in the user terminal 20 of the remittance source user or may be another user (for example, a remittance destination user to which the remittance source user has remitted electronic money in the past) registered in the settlement service. The remittance source user may specify, as the remittance destination user, another user not displayed on the input screen SC2. The remittance source user may retrieve an account ID, a telephone number, and the like of the remittance destination user to specify the retrieved information as the remittance destination user. The remittance source user may not particularly specify the remittance destination user on the input screen SC2, and may use means (for example, an electronic mail or a message app) different from the settlement app to transmit a link for the reception to the remittance destination user.

For example, when the remittance source user specifies the remittance destination user on the input screen SC2 on the upper right side of FIG. 2, the user terminal 20 of the remittance source user displays the input screen SC2 for receiving input of details of the electronic money to be remitted to the remittance destination user on the display unit 25 as illustrated on the lower left side of FIG. 2. In the example of the lower left side of FIG. 2, the input screen SC2 includes an input form F20 for receiving input of an amount of money and an input form F21 for receiving input of a message to the remittance destination user. The remittance source user inputs any amount of money to the input form F20. The remittance source user inputs any message to the input form F21. The remittance source user may omit the input of the message to the input form F21.

In the at least one embodiment, based on the generative model managed by the external system 2, content C to be displayed at at least one of the time of the remittance of the electronic money by the remittance source user to the remittance destination user or the time of the reception of the electronic money by the remittance destination user from the remittance source user is generated. In the at least one embodiment, there is exemplified a case in which the content C is displayed at both of the times, but the content C may be displayed at only any one of those times. Details of the generative model are described later.

In the example of the lower left side of FIG. 2, the input screen SC2 includes an input form F22 for receiving input of a substance of the content C which the remittance source user desires. For example, the remittance source user inputs, to the input form F22, a text “I like an image including many flowers.” The remittance source user may omit the input to the input from F22. In this case, the generative model may not generate the content C, or may generate background information based on other information as in modification examples described later.

For example, when the remittance source user inputs, to the input form F22, the substance of the content C desired by the remittance source user and then selects a button B23, the generative model generates the content C based on the substance input to the input form F22. When the generative model generates the content C, the user terminal 20 of the remittance source user displays a confirmation screen SC3 for the remittance source user to make final confirmation on the display unit 25 as illustrated on the lower right side of FIG. 2. The confirmation screen SC3 includes the content C. When the remittance source user slides a slide bar B30, the electronic money is remitted from the remittance source user to the remittance destination user. The remittance destination user starts the settlement app stored in his or her own user terminal 20 to execute an operation for receiving the electronic money.

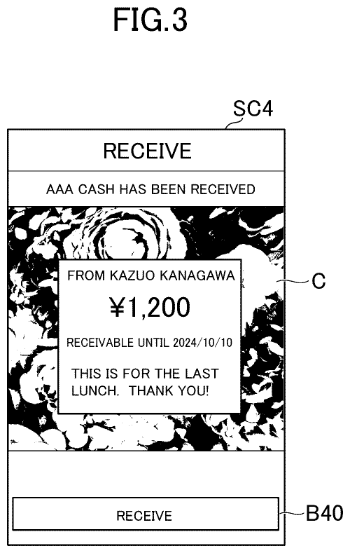

FIG. 3 is a view for illustrating an example of a screen displayed on the user terminal 20 of the remittance destination user. For example, when the remittance destination user operates his or her own user terminal 20 to start the settlement app, the user terminal 20 of the remittance destination user displays a reception screen SC4 for the remittance destination user to receive the electronic money on the display unit 25 as illustrated in FIG. 3. The reception screen SC4 includes the content C generated by the generative model. When the remittance destination user selects a button B40, the reception of the electronic money is completed. On the reception screen SC4, input of a message from the remittance destination user to the remittance source user may be received. The content C may be generated by the generative model based on this message.

As described above, the content providing system 1 according to the at least one embodiment displays the content C generated by the generative model on each of the confirmation screen SC3 displayed on the user terminal 20 of the remittance source user and the reception screen SC4 displayed on the user terminal 20 of the remittance destination user. Thus, the content providing system 1 is capable of providing appropriate content C corresponding to the settlement service for remitting the electronic money among the plurality of users. Details of the content providing system 1 are now described.

### 3. Functions Implemented in Content Providing System

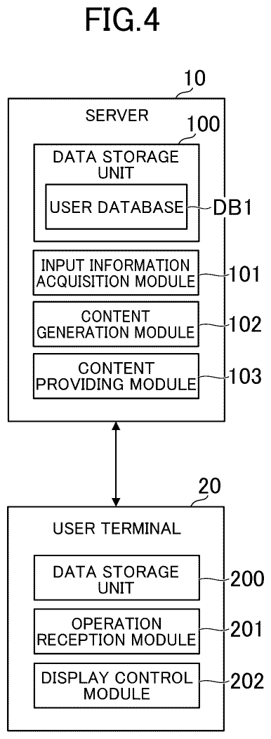

FIG. 4 is a diagram for illustrating an example of functions implemented in the content providing system 1. Each component implemented by the content providing system 1 according to the at least one embodiment can be configured so that, for example, the components are unified into one device or more finely divided to be distributed to devices.

### 3-1. Functions Implemented in Server

For example, the server 10 includes a data storage unit 100, an input information acquisition module 101, a content generation module 102, and a content providing module 103. The data storage unit 100 is implemented by the storage unit 12. Each of the input information acquisition module 101, the content generation module 102, and the content providing module 103 is implemented by the control unit 11.

### Data Storage Unit

The data storage unit 100 stores various types of data to be used in the settlement service. For example, the data storage unit 100 stores a user database DB1.

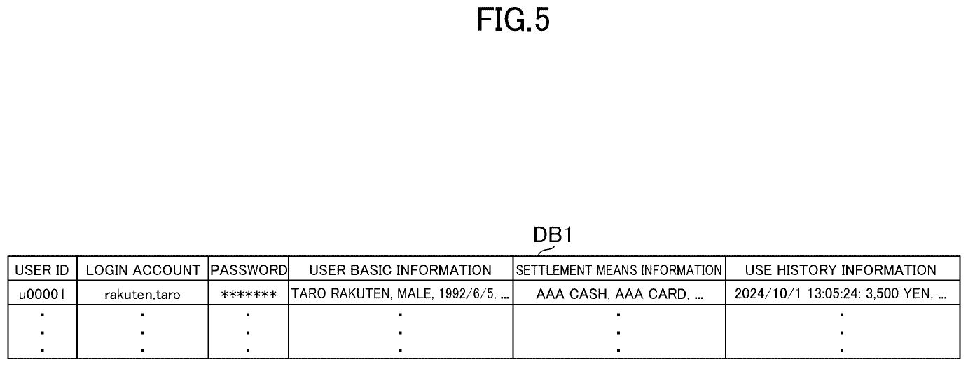

FIG. 5 is a table for showing an example of the user database DB1. The user database DB1 is a database in which various types of information on each of the plurality of users are stored. For example, in the user database DB1, a user ID, a login account, a password, user basic information, settlement means information, and use history information are stored. The information stored in the user database DB1 is not limited to the example of FIG. 5. In the user database DB1, other information may be stored. For example, in the user database DB1, a history of pieces of content C generated in the past and information on the users being the candidates of the remittance destination user may be stored.

The user ID is an example of user identification information with which the user is identifiable. The login account is also an example of the user identification information. The login account is the user identification information input by the user to log in to the settlement service. The login account may be designed so that the user can freely change the login account. The user ID is user identification information managed independently of the login account. In the at least one embodiment, there is exemplified a case in which the login account exists independently of the user ID (a case in which at least two pieces of user identification information exist), but the number of pieces of the user identification information may be only one. That is, the user ID and the login account may not be separated from each other. The password is authentication information to be checked at the login. The login account and the password may be biometric information on the user.

The user basic information is basic information on the user. The user may be allowed to edit his or her own user basic information. The user basic information may be information called demographic. The user basic information may indicate attributes of the user. For example, the user basic information may be the name, the gender, the date of birth, the age or the age group, the address, preferences, the occupation, information on the workplace, or types of service in use of the user, or a combination thereof.

The settlement means information is information with which settlement means available for the user in the settlement service is identifiable. For example, the settlement means information is information on a credit card number and the like, information on an electronic money number and the like, information on a bank account and the like, or information on a loyalty point card number and the like. The settlement means information may indicate the balance of the electronic money. When the remittance source user remits the electronic money to the remittance destination user, the balance of the electronic money of the remittance source user decreases. When the remittance destination user receives the electronic money from the remittance source user, the balance of the electronic money of the remittance destination user increases. The balance of the electronic money at the current time may be managed on another computer other than the server 10.

The use history information is information on a history of use of the settlement service by the user. For example, the use history information may indicate a name of a shop at which the user used the settlement service to make settlement, an amount of the settlement, and a date and time of the settlement. The use history information on each user may indicate the amount of money of the electronic money remitted by this user as the remittance source user to the remittance destination user, information on the remittance destination user, and a date and time of the remittance. The use history information on each user may indicate the amount of money of the electronic money received by this user as the remittance destination user from the remittance source user, information on the remittance source user, and a date and time of the reception. The use history information on each user is updated each time this user uses the settlement service.

The data stored in the data storage unit 100 is not limited to the above-mentioned example. The data storage unit 100 may store other data in the settlement service. For example, the data storage unit 100 may store data required to display the top screen SC1, the input screen SC2, the confirmation screen SC3, the reception screen SC4, and other screens. In the at least one embodiment, there is exemplified a case in which the external system 2 stores actual data on the generative model, but the data storage unit 100 may store the actual data on the generative model. In this case, the external system 2 may be omitted.

The generative model is a model capable of generating the content C to be provided in a service in which a monetarily valuable item is transmitted among a plurality of users. In the at least one embodiment, there is exemplified a case in which the “item” of the monetarily valuable item is an intangible, but the “item” may be a tangible. When the monetarily valuable item is an intangible, the monetarily valuable item may be electronic data. In this case, the monetarily valuable item can also be considered as an electronic value. The monetarily valuable item may be valuable as an asset or may not particularly be classified as the asset.

In the at least one embodiment, the electronic money is described as an example of the monetarily valuable item. Thus, “electronic money” as used in the at least one embodiment can be read as “monetarily valuable item.” It is only required that the monetarily valuable item be an item having a certain value, and the monetarily valuable item is not limited to the electronic money. For example, the monetarily valuable item may be a balance not called electronic money, a crypto-asset, a coupon, loyalty points, an electronic ticket (for example, an admission ticket to a sporting event or another event) a digital token, an electronic gift, a voucher for an article, a ticket for using a service, electronic content, or another item. The monetarily valuable item may be an item (for example, an article) itself or a service (for example, a service provided in a shop) itself.

The service in which the monetarily valuable item is transmitted among a plurality of users is a service which provides a function for transmitting the monetarily valuable item to each of the plurality of users. In the at least one embodiment, the settlement service is described as an example of this service. This service is only required to be a service having a function for transmitting a certain item having a monetary value, and may be another service. For example, this service may be a financial service, an electronic commerce service, a social networking service (SNS), a message app service, a chat service, a short message service (SMS), a ticket sales service, a communication service, a travel reservation service, or another service. “Settlement service” as used in the at least one embodiment can be read as any one of those services.

In the at least one embodiment, the generative model includes a program which indicates a series of steps of processing for generating the content C based on information input to the generative model itself and parameters to be referred to by this program. The information input to the generative model is hereinafter referred to as “input information.” The generative model may not particularly include the parameters, and the program itself may correspond to the generative model. Moreover, the parameters may be built into a part of the program of the generative model. The generative model may include information other than the program and the parameters.

In the at least one embodiment, there is exemplified a case in which a generative artificial intelligence (AI) capable of generating the content C corresponds to the generative model. The generative AI is an AI capable of generating an electronic product based on the input information input to the generative AI itself. There are various definitions of the generative AI, and the generative AI in the at least one embodiment may be a generative AI defined in any one of publicly-known various definitions. For example, the generative AI is not only an AI developed through a method of machine learning, but may be an AI developed through another method other than machine learning. The generative AI may be an AI of a single-modal type capable of processing only the input information in a specific form, or may be an AI of a multimodal type capable of processing the input information in a plurality of forms.

The content C is information (data) to be electronically provided to the user. The content C is not limited to visual information, but may be auditory information. In the at least one embodiment, a background image corresponding to a background of a screen of the settlement app is described as an example of the content C. The content C is only required to be certain information provided to the user, and is not limited to the background image. For example, the content C may be another image (for example, an image corresponding to a foreground) other than the background image, a moving image, a sound, an electronic mail, another message other than an electronic mail (for example, a message of a message app), a notification in an application such as the settlement app, or other information.

For example, the generative model may be a large language model, a machine learning model not classified into a large language model (model trained through use of a method of machine learning, for example, a model such as a generative adversarial network (GAN) and a variational autoencoder (VAE)), or another model. For example, the generative model may be a model of the Dall-E series or a generative AI (so-called image generation AI) such as Midjourney, Stable Diffusion, Artbreeder, Deep Dream Generator, or Runway ML.

The generative model may include a large language model (for example, a transformer-based model such as generative pre-trained transformer (GPT) or another model such as a neural network not classified into the transformer) and another model (for example, the model of the Dall-E series) which cooperates with this large language model to generate the content C. That is, the generative model may be formed of a plurality of models. Moreover, the generative model may be a model which is not called generative AI. For example, a machine learning model not called generative AI may correspond to the generative model.

Moreover, it is assumed that the generative model has learned various types of content C for training as training data. When a model exemplified by the large language model and capable of executing natural language processing corresponds to the generative model, it is assumed that the generative model has learned various texts for training as the training data. The parameters of the generative model have been adjusted through the learning of the training data. A pre-trained general-purpose generative model may directly be used, or a generative model fine-tuned for the content providing system 1 may be used.

Moreover, the parameters of the generative model may be the same as publicly-known parameters. For example, the parameters of the generative model may be weights or biases. The generative model may include a plurality of layers such as an input layer, an intermediate layer, and an output layer. The training method for the generative model may be the same as a publicly-known method for machine learning. As in the definition of the AI, there are various definitions of machine learning, and the machine learning in the at least one embodiment includes publicly-known various definitions. For example, it is assumed that deep learning is included in the machine learning.

### Input Information Acquisition Module

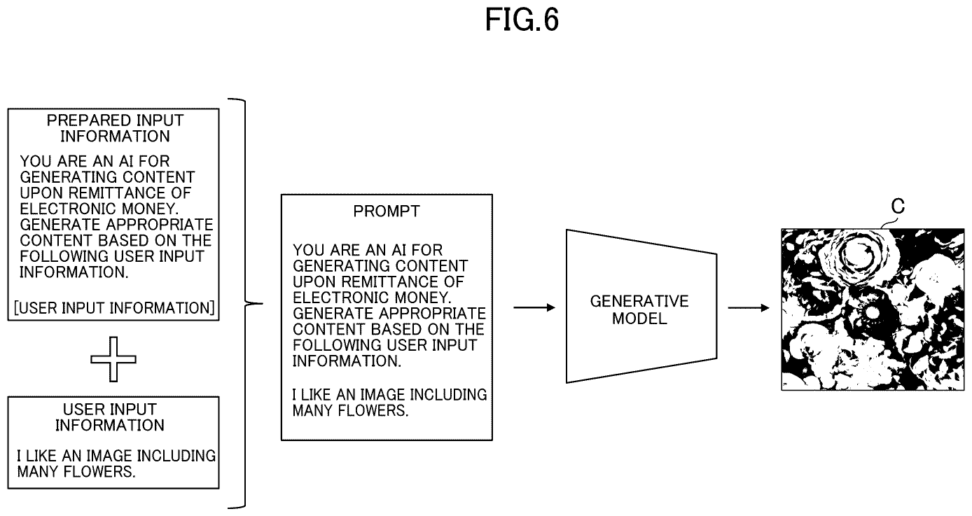

FIG. 6 is a diagram for illustrating an example of input to and output from the generative model. With reference to FIG. 6, description is now given of each function of the input information acquisition module 101 and the like. The input information acquisition module 101 acquires the input information input to the generative model. In the at least one embodiment, there is exemplified a case in which the input information indicates a text described in a form of sentences in a natural language, but the input information may be in any form which can be processed by the generative model. For example, the input information may be a text in a natural language not in the form of sentences, a text not in a natural language, a file of an image, a moving image, a document, or the like, another form, or a combination thereof. The text is not limited to characters, and may be numbers, or may be symbols other than characters and numbers.

The input information acquisition module 101 can acquire the input information from any location. For example, when the input information is input by the user, the input information acquisition module 101 acquires the input information from the user terminal 20. When the input information is stored in advance in the data storage unit 100, the input information acquisition module 101 acquires the input information from the data storage unit 100. When the input information is stored in an information storage medium, the input information acquisition module 101 acquires the input information from the information storage medium. When the input information is stored in another computer other than the server 10 and the user terminal 20, the input information acquisition module 101 acquires the input information from the another computer. The input information acquisition module 101 may combine the pieces of information acquired from those plurality of locations, to thereby acquire combined information as the input information.

In the at least one embodiment, there is exemplified a case in which the generative model is a model of the generative AI capable of generating the content C, and hence the input information acquisition module 101 acquires, as the input information, a prompt for instructing the generative model to generate the content C. The prompt is an instruction issued to the generative model. The prompt may be a text written in a natural language understandable by humans or other information other than this text. For example, the prompt may be a text written in another language other than natural languages (for example, a program code written in a programming language or a structured text written in a markup language), a file such as an image or a document, or other information. The prompt may be a combination of those pieces of information.

In the at least one embodiment, the input information acquisition module 101 acquires user input information relating to the input received on the input screen SC2 for any one of the plurality of users to remit or request for the electronic money, and acquires the prompt based on the user input information. The user input information is input information input by the user. In the examples of the upper right side and the lower left side of FIG. 2, the input screen SC2 for the remittance source user to remit the electronic money to the remittance destination user is illustrated, and hence the user input information is the input information input by the remittance source user. The user input information may indicate the whole of the information input on the input screen SC2 or a part of the information input on the input screen SC2.

For example, the input information acquisition module 101 may acquire the user input information indicating the substance of the content C input on the input screen SC2 by any one of the plurality of users. The substance of the content C can be considered as details or a feature of the content C. For example, the substance of the content C may be an object, a color, a pattern, brightness, a visual concept, or a combination thereof indicated in the content C. On the input screen SC2, images indicating rough coloring may be displayed, and the user input information may indicate an image selected therefrom.

In the at least one embodiment, there is exemplified a case in which the user input information indicates the substance of the content C desired by the remittance source user, but the user input information may indicate the substance of the content C desired by the remittance destination user. That is, the substance of the content C may be input by the remittance source user or may be input by the remittance destination user.

In the example of the lower left side of FIG. 2, the remittance source user inputs the substance of the content C to the input form F22. Thus, the user input information indicates a text input to the input form F22. For example, when the remittance source user inputs a text “I like an image including many flowers.” to the input form F22, the user terminal 20 transmits the user input information indicating this text to the server 10. The input information acquisition module 101 acquires the user input information from the user terminal 20.

In the at least one embodiment, there is exemplified a case in which the user input information indicates only the substance of the content C, but the user input information may indicate the substance of the content C and other information other than the substance of the content C. The user input information may not indicate the substance of the content C, and may indicate only other information. An example of the other information is described in the modification examples described later. The user input information may indicate a plurality of pieces of other information. The user input information may indicate the substance of the content C and a plurality of pieces of other information.

In the at least one embodiment, the input information acquisition module 101 acquires prepared input information relating to the input and prepared in advance, and acquires the prompt further based on the prepared input information. The prepared input information is the input information prepared in advance. The prepared input information is not the user input information input by the user, but the input information prepared by the content providing system 1 side. When the prepared input information is used as the whole or a part of the prompt, the prepared input information may be considered as a default prompt. The prepared input information is at least a part of the prompt.

When the generative model is not a model specialized in the generation of the content C, but a general-purpose model capable of also generating other products (for example, a text) other than the content C, it is required for the content providing system 1 to instruct the generative model to generate the content C. Thus, the prepared input information may indicate a substance of processing to be executed by the generative model. The processing to be executed by the generative model may be considered as a task of the generative model. In the at least one embodiment, the generation of the content C corresponds to the task. For example, the prepared input information indicates a text in which it is written in a natural language that the generative model is to generate the content C based on the prompt.

For example, the input information acquisition module 101 may acquire the prepared input information indicating that the generative model is to generate the content C corresponding to the user input information. The prepared input information indicates a text which instructs the generative model to generate the content C corresponding to the user input information. In the example of FIG. 6, the prepared input information indicates a text “You are an AI for generating content upon remittance of electronic money. Generate appropriate content based on the following user input information.” In the prepared input information, it may be indicated that the background image is to be generated as the content C.

“[USER INPUT INFORMATION]” of FIG. 6 is a tag indicating a position at which the user input information is to be set. Thus, the input information acquisition module 101 sets the user input information at a portion of the prepared input information that is indicated by the tag, to thereby acquire a final prompt. The setting of the user input information means the insertion of the user input information. The user input information may not be built into the prepared input information, but may be input to the generative model independently of the prepared input information.

The input information acquisition module 101 may not acquire the prepared input information, but may acquire the user input information directly as the prompt. The input information acquisition module 101 may not acquire the user input information, but may acquire the prompt. For example, the input information acquisition module 101 may not acquire the user input information, but may acquire, as the prompt, input information described in the modification examples described later. When the generative model is not a generative AI, the input information acquisition module 101 may acquire input information which is not called prompt.

Moreover, the remittance source user may not voluntarily remit the electronic money to the remittance destination user, but the remittance destination user may request the electronic money from the remittance source user. That is, the remittance source user may remit the electronic money to the remittance destination user in response to the request by the remittance destination user. In this case, information input by the remittance destination user at the time of the request for the electronic money from the remittance source user corresponds to the user input information.

For example, a screen for the remittance destination user to input necessary items required to request the electronic money from the remittance source user corresponds to “an input screen for any one of the plurality of users to request the electronic money.” On this screen, input of at least one of the amount of money of the electronic money requested from the remittance source user, a message from the remittance destination user to the remittance source user, or the substance of the content C desired by the remittance destination user may be received. The user input information may be those pieces of information input on this screen.

The input information is only required to be the information input to the generative model, and is not limited to the example in the at least one embodiment. For example, the input information may include only the user input information or may include only the prepared input information. The input information may include information in the modification examples described later, or may indicate a relationship among the plurality of users to which the electronic money is to be remitted. When a sample of the content C is stored in the data storage unit 100, the input information may include the sample. For example, a method called retrieval augmented generation (RAG) in which samples accumulated in a database are used may be used for the generation of the content C. The input information may be information on the remittance executed in the past.

Moreover, in the case in which the generative model is the model specialized in the generation of the content C, the generative model can generate the content C without using the prompt to instruct the generation of the content C, and hence the generation of the content C is not required to be indicated in the prompt. Also in a case in which the generative model is a general-purpose model which is not specialized in the generation of the content C, but the generation of the content C can be set as the setting of the generative model, the generative model can generate the content C even when the generation of the content C is not instructed through the prompt, and hence the generation of the content C is not required to be indicated in the prompt.

### Content Generation Module

The content generation module 102 causes the generative model to generate the content C based on the input information. The content generation module 102 inputs the input information to the generative model, to thereby cause the generative model to generate the content C. In the at least one embodiment, the prompt is acquired as the input information, and hence the content generation module 102 causes the generative model to generate the content C based on the prompt. The content generation module 102 inputs the prompt to the generative model, to thereby cause the generative model to generate the content C. The content generation module 102 acquires the content C generated by the generative model.

In the at least one embodiment, the actual data on the generative model is stored in the external system 2, and hence the content generation module 102 transmits the input information to the external system 2, to thereby cause the generative model to generate the content C. When the external system 2 acquires the input information from the server 10, the external system 2 inputs the input information to the generative model managed by the external system 2 itself. The external system 2 transmits, to the server 10, the content C generated by the generative model. The content generation module 102 acquires, from the external system 2, the content C generated by the generative model. When the actual data of the generative model is stored in the data storage unit 100, it is only required for the content generation module 102 to input the input information to the generative model stored in the data storage unit 100, to thereby cause the generative model to generate the content C.

Processing itself executed by the generative model may be the same as publicly-known processing. The generative model may generate the content C corresponding to the input information through the same processing as that of a publicly-known generative AI. For example, the generative model calculates an embedded expression of the input information based on the learned parameters. The embedded information is information for the generative model to recognize meaning. For example, the embedded expression may be a multi-dimensional vector or may be in another form other than a multi-dimensional vector (for example, an array form, a matrix form, a plurality of numerical values, a single numerical value, or a feature map). When an image is included in the input information, processing for convolution may be executed.

For example, the generative model outputs the content C corresponding to the embedded expression of the input information. The generative model may divide the input information into processing units called tokens, and then calculate the embedded expressions of individual tokens. The generative model predicts, as required, the following part based on a sequence of the embedded expressions of the individual tokens, and then outputs the content C. The generative model may include an input layer which receives the input of the input information, an intermediate layer which calculates the embedded expression, and an output layer which outputs the content C corresponding to the embedded expression. The series of steps of processing of generating the content C from the input information may be executed based on those layers. The parameters may be associated with each of those layers.

In the example of FIG. 6, when the remittance source user inputs the user input information “I like an image including many flowers.,” the generative model recognizes, based on the embedded expression of the user input information, that the generation of an image showing many flowers is instructed. The generative model generates and outputs the content C showing many flowers as the content C corresponding to this embedded expression. It is assumed that the generative model has learned, in advance, images of various flowers for training and thus the generative model can generate the images of flowers through the pre-training.

It is only required that the generative model generate at least one piece of content C based on one piece of input information. The generative model may generate only one piece of content C or may generate a plurality of pieces of content C. The number of pieces of content C to be generated by the generative model may be indicated in the input information. For example, the number of pieces of content C to be generated by the generative model may be indicated in the user input information, or may be indicated in the prepared input information. Moreover, the generative model may generate a plurality of types of content C such as a background image and a moving image. The type of content C to be generated by the generative model may be indicated in the input information. For example, the type of content C to be generated by the generative model may be indicated in the user input information, or may be indicated in the prepared input information.

Moreover, the content generation module 102 may cause the generative model to generate the content C to be provided to the remittance source user and the content C to be provided to the remittance destination user such that those pieces of content C are not the same, but are different from each other. In this case, the content generation module 102 causes the generative model to generate first content C to be provided to the remittance source user. The first content C is not provided to the remittance destination user. The content generation module 102 causes the generative model to generate second content C which is different from the first content C and is to be provided to the remittance destination user. The second content C is not provided to the remittance source user.

Moreover, the content generation module 102 may cause the generative model to correct the content C. For example, the remittance source user may input a substance of the correction to the content C displayed on the confirmation screen SC3. For example, the remittance source user can instruct the correction to the content C displayed on the confirmation screen SC3 or a change to another piece of content C. In this case, this correction substance corresponds to the user input information at the time of correction. The content generation module 102 inputs this correction substance to the generative model, and the generative model corrects the content C. The correction of the content C may be executed through the same processing as correction in a publicly-known generative AI. The content generation module 102 acquires the content C corrected by the generative model. The content generation module 102 may not cause the generative model to correct the content C, but may cause the generative model to generate again a completely new piece of content C.

### Content Providing Module

The content providing module 103 provides the content C generated by the content generation module 102 to at least one of the plurality of users. At least one of the plurality of users is at least one of the remittance source user or the remittance destination user. In the plurality of users, a plurality of remittance source users may be included and a plurality of remittance destination users may be included. The provision of the content C is to transmit the content C to the user terminal 20. In the at least one embodiment, there is exemplified a case in which the content providing module 103 provides the content C on the screen of the settlement app, but the content providing module 103 may use an electronic mail, a message app, an SNS, a communication function of the user terminal 20, or another means to provide the content C.

In the example of the lower right side of FIG. 2, the content providing module 103 transmits display data on the confirmation screen SC3 including the content C to the user terminal 20 of the remittance source user, to thereby provide content C being an example of the content C to the remittance source user. In the example of FIG. 3, the content providing module 103 transmits display data on the reception screen SC4 including the content C to the user terminal 20 of the remittance destination user, to thereby provide the content C to the remittance destination user. The content providing module 103 may provide the content C on a history screen indicating a history of the remittance executed in the past, a notification function screen in the settlement app, or another screen.

The content C to be provided to the remittance source user and the content C to be provided to the remittance destination user may be different from each other. In this case, the content providing module 103 may provide the first content C to the remittance source user and may provide the second content C different from the first content C to the remittance destination user. Moreover, the content providing module 103 may provide the content C to only the remittance source user. The content providing module 103 may provide the content C to only the remittance destination user. The content providing module 103 may provide the content C to another user different from the remittance source user and the remittance destination user.

### 3-2. Functions Implemented in User Terminal

For example, the user terminal 20 includes a data storage unit 200, an operation reception module 201, and a display control module 202. The data storage unit 200 is implemented by the storage unit 22. The operation reception module 201 and the display control module 202 are implemented by the control unit 21.

### Data Storage Unit

The data storage unit 200 stores data required for the user to use the settlement service. For example, the data storage unit 200 stores the settlement app. When the user uses the settlement service not from the settlement app, but from another app or the browser, the data storage unit 200 stores the another app or the browser.

### Operation Reception Module

The operation reception module 201 receives various operations of the user. For example, the operation reception module 201 receives an operation executed on the settlement app. The operation reception module 201 transmits, to the server 10, data indicating an operation substance of the user.

### Display Control Module

The display control module 202 displays various screens on the display unit 25. For example, the display control module 202 displays each of the top screen SC1, the input screen SC2, the confirmation screen SC3, and the reception screen SC4 on the display unit 25. The display control module 202 communicates to and from the server 10 to receive the display data on those screens, and displays those screens on the display unit 25 based on the display data. The display data is data required to display the screens. The display data may be data on the entire screen or may be data on a part of the screen. For example, the display data may be data in a markup language such as HTML, image data, text data, or other data.

### 4. Processing Executed in Content Providing System

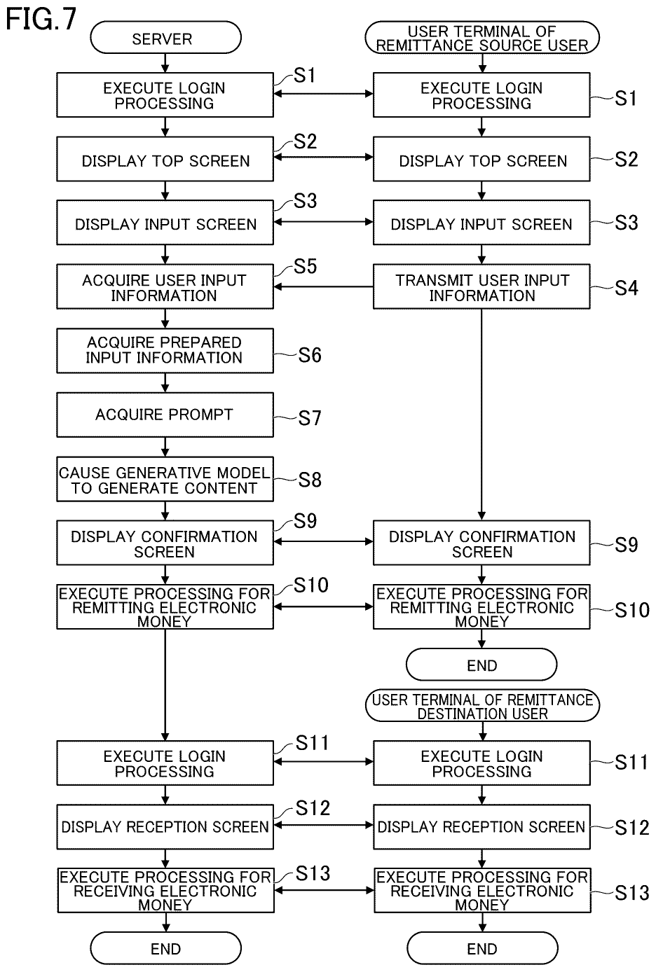

FIG. 7 is a flowchart for illustrating an example of processing executed in the content providing system 1. In FIG. 7, out of the processing steps executed in the content providing system 1, processing steps relating to the generation of the content C are illustrated. The processing of FIG. 7 is executed by the control units 11 and 21 executing the programs stored in the storage units 12 and 22, respectively. Steps of FIG. 7 are an example of a content providing method. In FIG. 7, processing executed when the remittance source user remits the electronic money to the remittance destination user is illustrated.

As illustrated in FIG. 7, when the settlement app starts, the user terminal 20 of the remittance source user executes, between the user terminal 20 and the server 10, login processing for the remittance source user to log in to the settlement service (Step S1). When the login processing is successful, the server 10 executes processing for displaying the top screen SC1 between the server 10 and the user terminal 20 of the remittance source user (Step S2). When the remittance source user selects the button B10, the server 10 executes processing for displaying the input screen SC2 between the server 10 and the user terminal 20 of the remittance source user (Step S3).

In Step S3, the server 10 acquires data on a phonebook of the user terminal 20 as required, generates the display data on the input screen SC2, and transmits the display data to the user terminal 20. On the user terminal 20, the input screen SC2 on the upper right side of FIG. 2 is displayed. When the remittance source user selects the remittance destination user, the user terminal 20 transmits, to the server 10, the user identification information on this selected remittance destination user. When the server 10 acquires, from the user terminal 20, the user identification information on the remittance destination user, the server 10 transmits the display data on the input screen SC2 on the lower left side of FIG. 2 to the user terminal 20. The user terminal 20 receives the input to the input form F20 and the like.

When the remittance source user inputs required items on the input screen SC2 on the lower left side of FIG. 2, the user terminal 20 of the remittance source user transmits the user input information to the server 10 (Step S4). In the at least one embodiment, the substance of the content C input to the input form F22 corresponds to the user input information, and hence the user terminal 20 transmits, to the server 10, the user input information indicating the substance of the content C input by the remittance source user. The user terminal 20 also transmits, to the server 10, other information such as the substance input to the input form F20.

The server 10 acquires the user input information from the user terminal 20 of the remittance source user (Step S5). The server 10 acquires the prepared input information stored in the storage unit 12 (Step S6). The server 10 acquires, as the input information, the prompt based on the user input information and the prepared input information (Step S7). In Step S7, the server 10 sets the user input information at a predetermined position of the prepared input information, to thereby acquire the prompt. The server 10 transmits, as the input information, the prompt to the external system 2, to thereby cause the generative model to generate the content C (Step S8). In Step S8, the server 10 acquires, from the external system 2, the content C generated by the generative model.

The server 10 executes processing for displaying the confirmation screen SC3 including the content C between the server 10 and the user terminal 20 of the remittance source user (Step S9). In Step S9, the server 10 transmits display data on the confirmation screen SC3 including the content C to the user terminal 20, to thereby provide the content C to the remittance source user. When the remittance source user slides the slide bar B30, the server 10 executes, between the server 10 and the user terminal 20 of the remittance source user, the processing for remitting the electronic money from the remittance source user to the remittance destination user (Step S10). The processing executed in Step S10 may be the same as processing employed in the publicly-known settlement service. In Step S10, the server 10 updates the use history information on the remittance source user and the use history information on the remittance destination user so that each of those pieces of use history information indicates the remittance of the electronic money. At a time point of Step S10, the balance of the electronic money of the remittance source user may decrease, and the balance of the electronic money of the remittance destination user may increase.

When the settlement app starts, the user terminal 20 of the remittance destination user executes, between the user terminal 20 and the server 10, the login processing for the remittance destination user to log in to the settlement service (Step S11). When the login processing is successful, the server 10 executes, between the server 10 and the user terminal 20 of the remittance destination user, processing for displaying the reception screen SC4 including the content C (Step S12). It is assumed that the content C generated in Step S8 is stored in the user database DB1. In Step S12, the server 10 generates the display data on the reception screen SC4 including the content C stored in the user database DB1, and transmits the display data to the user terminal 20 of the remittance destination user. When the remittance destination user selects the button B40, the server 10 executes, between the server 10 and the user terminal 20 of the remittance destination user, the processing for receiving the electronic money remitted to the remittance destination user from the remittance source user (Step S13), and this processing is finished. The processing of Step S13 may be the same as processing employed in the publicly-known settlement service.

### 5. Summary of at Least One Embodiment

The content providing system 1 according to the at least one embodiment acquires the input information which is input to the generative model. The content providing system 1 causes the generative model to generate the content C based on the input information. The content providing system 1 provides the content C to at least one of the plurality of users. As a result, the content providing system 1 does not provide an image and the like prepared on the administrator side, but the content C generated by the generative model, thereby being able to provide appropriate content C corresponding to the settlement service. For example, when no background exists in the confirmation screen SC3, the remittance source user possibly feels that the confirmation screen SC3 is tasteless and insufficient. However, the content C generated by the generative model is provided to the remittance source user, and hence the remittance source user can feel designability of the confirmation screen SC3. When no background exists in the reception screen SC4, the remittance destination user possibly feels that the reception screen SC4 is tasteless and insufficient. However, the content C generated by the generative model is provided to the remittance destination user, and hence the remittance destination user can feel the designability of the reception screen SC4. The content providing system 1 can also add an added value to the settlement service in the form of the provision of the content C. The user can communicate with the opposite party through the content C, and hence the content providing system 1 can increase amusement of the user.

Moreover, the generative model is a model of the generative AI capable of generating the content C. The content providing system 1 acquires, as the input information, the prompt for instructing the generative model to generate the content C. The content providing system 1 causes the generative model to generate the content C based on the prompt. As a result, the content providing system 1 can control the content C generated by the generative AI through use of the prompt, and hence can provide more appropriate content C.

Moreover, the content providing system 1 acquires the user input information relating to the input received on the input screen SC2 for any one of the plurality of users to remit or request the electronic money. The content providing system 1 acquires the prompt based on the user input information. As a result, the content providing system 1 can use the user input information directly input on the input screen SC2 to provide the content C more appropriately reflecting an intention of the user.

Moreover, the content providing system 1 acquires the user input information indicating the substance of the content C input on the input screen SC2 by any one of the plurality of users. As a result, the content providing system 1 can provide appropriate content C directly reflecting the substance of the content C desired by the user. For example, the content providing system 1 can generate content reflecting the intention of the remittance source user based on the user input information input by the remittance source user. The content providing system 1 can generate the content reflecting the intention of the remittance destination user based on the user input information input by the remittance destination user.

Further, the content providing system 1 acquires prepared input information relating to the input and prepared in advance, and acquires the prompt further based on the prepared input information. As a result, the content providing system 1 can provide appropriate content C through the prepared input information even when the user does not input the entire substance of the prompt. For example, even when only the user input information is insufficient as the prompt, the content providing system 1 can supplement the information required for the generation of the content C with the prepared input information.

Moreover, the content providing system 1 acquires the prepared input information indicating that the generative model is to generate the content C corresponding to the user input information. As a result, the content providing system 1 can use the prepared input information to instruct the generative model to generate the content C corresponding to the user input information, thereby being able to more reliably generate the content C corresponding to the user input information.

### 6. Modification Examples

The present disclosure is not limited to the at least one embodiment described above. The present disclosure can be modified suitably without departing from the spirit of the present disclosure.

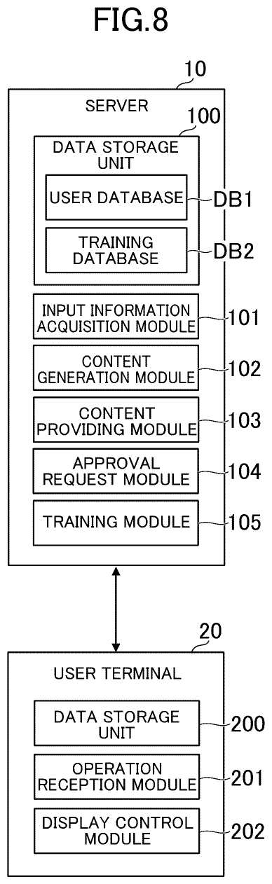

FIG. 8 is a diagram for illustrating an example of functions implemented in the modification examples. For example, the server 10 includes an approval request module 104 and a training module 105. Each of the approval request module 104 and the training module 105 is implemented by the control unit 11.

### 6-1. Modification Example 1

For example, the input information acquisition module 101 may acquire the prepared input information indicating that the generative model is to generate the content C corresponding to past content generated by the generative model in the past. The past content is the content C provided in the past to at least one of the plurality of users. The content C corresponding to the past content is content C which is the same as the past content, content C which is not the same as the past content but has the same feature as that of the past content, or content C which is not the same as the past content and has a feature different from that of the past content. The feature as used herein is a visual feature. For example, the feature is an object, a color, a pattern, brightness, a visual concept, or a combination thereof indicated in the past content or the content C.

For example, a selection made by the user may be received from first prepared input information including words which instruct the generative model to generate the content C which is the same as the past content, second prepared input information including words which instruct the generative model to generate the content C which is not the same as the past content but has the same feature as that of the past content, and third prepared input information including words which instruct the generative model to generate the content C which is not the same as the past content and has a feature different from that of the past content. The input information acquisition module 101 may acquire the prepared input information selected by the user from the first prepared input information, the second prepared input information, and the third prepared input information.

In Modification Example 1, there is exemplified a case in which the pieces of past content are stored in the user database DB1. Thus, the input information acquisition module 101 acquires the past content from the user database DB1. The past content may be stored in another database other than the user database DB1, another computer other than the server 10, or an information storage medium. In this case, the input information acquisition module 101 is only required to acquire the past content from the another database, the another computer, or the information storage medium. The past content may be associated with a user to which this past content was provided or a user who instructed the generation of this past content. When the content C to be provided to a certain user is to be generated or a certain user instructs the generation of the content C, the input information acquisition module 101 may acquire the past content associated with those users.

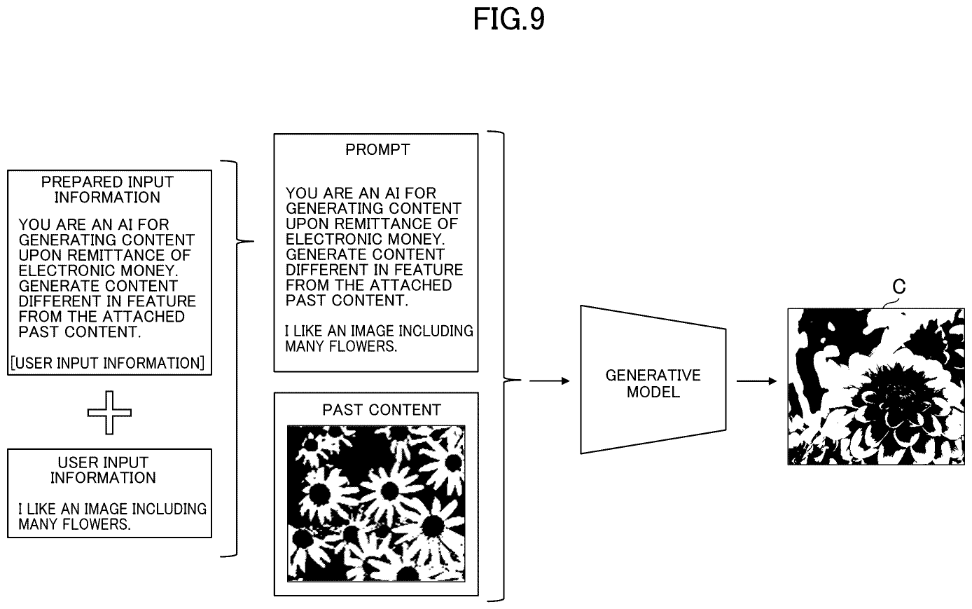

FIG. 9 is a diagram for illustrating an example of input to and output from the generative model in Modification Example 1. As illustrated in FIG. 9, the prepared input information in Modification Example 1 indicates a text which instructs the generative model to generate the content C corresponding to the past content. In the example of FIG. 9, the prepared input information indicates that the content C different from the past content in feature is to be generated. That is, the prepared input information indicates that the past content is to be excluded. For example, the prepared input information indicates a text “You are an AI for generating content upon remittance of electronic money. Generate content different in feature from the attached past content.”

In the example of FIG. 9, as in the at least one embodiment, the input information acquisition module 101 acquires the prompt including the user input information and the prepared input information. The input information acquisition module 101 in Modification Example 1 may not acquire the user input information, but acquire the prepared input information directly as the prompt. That is, in Modification Example 1, the user input information is not required to be acquired. The aspect in which the user input information is not acquired and the prepared input information in Modification Example 1 is acquired is also included within the scope of the present disclosure. The content providing system 1 according to Modification Example 1 is not required to have the function of acquiring the user input information.

It is assumed that the generative model in Modification Example 1 is a multimodal model capable of processing the text indicated by the prompt and the past content in the data format different from that of the text. The multimodal model is a model capable of processing data in a plurality of formats. It is assumed that the generative model has learned pieces of data for training in the plurality of formats. The multimodal model itself may have the same mechanism as that of a publicly-known model. When the past content is in an image format, the generative model is a model capable of processing the text and the image.

For example, the content generation module 102 inputs, to the generative model, the prompt and the past content acquired by the input information acquisition module 101. When the external system 2 manages the generative model, the content generation module 102 transmits the prompt and the past content to the external system 2, to thereby input the prompt and the past content to the generative model. When the generative model is stored in the data storage unit 100, it is only required for the content generation module 102 to input the prompt and the past content to the generative model stored in the data storage unit 100.

For example, the generative model calculates the embedded expression corresponding to the prompt and the past content based on the parameters adjusted through pre-training, and outputs the content C corresponding to the embedded expression. As illustrated in FIG. 9, when the generation of the content C different from the past content in feature is indicated in the prepared input information, the generative model recognizes, through the embedded expression in the portion of the prepared input information out of the prompt, that the content C different in feature from the past content input to the generative model itself is to be generated, and generates the content C having a feature different from the feature indicated by the embedded expression of the past content input to the generative model itself. In the example of FIG. 9, flowers indicated in the content C are larger in size than and different in shape from flowers indicated in the past content, and hence are different in feature from the past content.

When the prepared input information indicates that the generative model is to generate the content C which is the same as the past content, the generative model recognizes that the content C which is the same as the past content input to the generative model itself is to be generated, and generates the content C which is the same as the past content input to the generative model itself. When the prepared input information indicates that the generative model is to generate the content C which is not the same as the past content but has the same feature as that of the past model, the generative model recognizes that the content C which has the same feature as that of the past content input to the generative model itself is to be generated, and generates the content C which has the same feature as that of the past content input to the generative model itself.

Moreover, Modification Example 1 is different from the at least one embodiment in the substance indicated by the prepared input information and in the point that the past content is input to the generative model, but a flow of the processing (a flow in which the content generation module 102 acquires the content C generated by the generative model, and the content providing module 103 provides this content C) executed after the generative model generates the content C may be the same as that of the at least one embodiment.

The content providing system 1 according to Modification Example 1 acquires the prepared input information indicating that the generative model is to generate the content C corresponding to the past content. As a result, the content providing system 1 can provide appropriate content C corresponding to the past content to the user. For example, when the prepared input information indicates that the generative model is to generate the content C which is different in feature from the past model, the content providing system 1 can prevent such a situation that the content C similar to the past content is provided to the user many times, and hence the user gets tired thereof. When the prepared input information indicates that the generative model is to generate the content C having the same feature as that of the past content which the user likes, the content providing system 1 can provide the content C having the feature which the user likes.

### 6-2. Modification Example 2

For example, in the at least one embodiment, the substance of the content C input to the input form F22 has been described as the example of the user input information. The user input information is only required to be information input by the user, and is not limited to the example in the at least one embodiment. In Modification Example 2, another example of the user input information is described. In the examples of the input screen SC2 on the upper right side and the lower left side of FIG. 2, the user input information may be the remittance destination user specified by the remittance source user, the amount of money input to the input form F20, the message input to the input form F21, or a combination thereof. The user input information may indicate both of the substance of the content C described above in the at least one embodiment and the substance to be described in Modification Example 2.

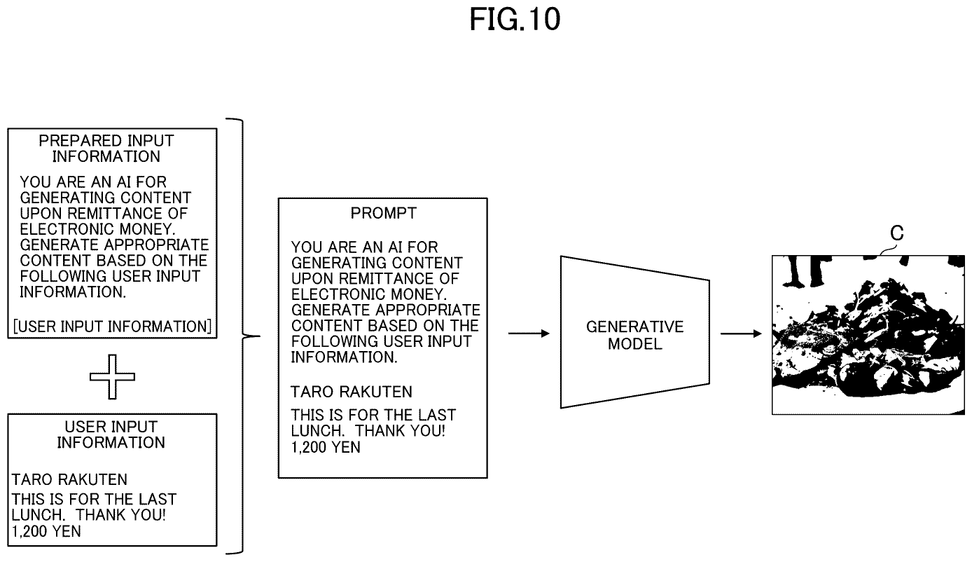

FIG. 10 is a diagram for illustrating an example of input to and output from the generative model in Modification Example 2. The input information acquisition module 101 in Modification Example 2 acquires the prompt based on at least one of the user identification information with which at least one of the plurality of users is identifiable, a message to this at least one user, or a substance relating to the electronic money. For example, the user input information may indicate at least one thereof, and the input information acquisition module 101 may acquire the prompt based on the user input information indicating at least one thereof. At least one of the user identification information, the message, or the substance relating to the electronic money is not required to be input by the user, and may be prepared in advance. In the example of FIG. 10, a case in which the user input information indicates all thereof is illustrated, but the user input information may indicate only one thereof or only two thereof.

For example, when the remittance source user inputs the user input information at the time of the remittance of the electronic money to the remittance destination user, the user input information indicates the user identification information on the remittance destination user specified by the remittance source user. The user input information may indicate the user identification information on each of the plurality of remittance destination users. When the remittance destination user inputs the user input information at the time of the request for the electronic money from the remittance source user, the user input information indicates the user identification information on the remittance source user specified by the remittance destination user. The user input information may indicate the user identification information on each of the plurality of remittance source users.

For example, when the remittance source user inputs a message to the remittance destination user at the time of the remittance of the electronic money to the remittance destination user, the user input information indicates the message input by the remittance source user. The user input information may indicate a message to each of the plurality of remittance destination users. When the remittance destination user inputs the message to the remittance source user at the time of the request for the electronic money from the remittance source user, the user input information indicates the message input by the remittance destination user. The user input information may indicate the message to each of the plurality of remittance source users.

In the example of FIG. 10, the amount of the electronic money corresponds to the substance relating to the electronic money. The substance relating to the electronic money may be another substance such as a reception due date/time and a payment due date/time. When the settlement service supports a plurality of types of electronic money, the substance relating to the electronic money may indicate the types of supported electronic money. When the remittance source user remits the electronic money to the remittance destination user, the user input information indicates the substance of the electronic money input by the remittance source user. The user input information may indicate the substance of the electronic money to each of the plurality of remittance destination users. When the remittance destination user requests the electronic money from the remittance source user, the user input information indicates the substance of the electronic money input by the remittance destination user. The user input information may indicate the substance of the electronic money requested from each of the plurality of remittance source users.

In the example of FIG. 10, as in the at least one embodiment, the input information acquisition module 101 acquires the prompt including the user input information and the prepared input information. For example, the prepared input information indicates a text “You are an AI for generating content upon remittance of electronic money. Generate appropriate content based on the following user input information.” This text may be the same as that of FIG. 6, but in the example of FIG. 10, the substance of the user input information set in the prepared input information is different.

The input information acquisition module 101 in Modification Example 2 may not acquire the prepared input information, but may acquire the user input information directly as the prompt. That is, in Modification Example 2, the prepared input information is not required to be acquired. An aspect in which the prepared input information is not acquired and the user input information in Modification Example 2 is acquired is also included within the scope of the present disclosure. The content providing system 1 according to Modification Example 2 is not required to have the function of acquiring the prepared input information.

For example, the content generation module 102 inputs the prompt to the generative model in the same manner as in the at least one embodiment. The generative model calculates the embedded expression corresponding to the prompt based on the parameters adjusted through the pre-training, and outputs the content C corresponding to the embedded expression. As illustrated in FIG. 10, when the generation of the content C corresponding to the user input information is indicated in the prepared input information, the generative model recognizes, through the embedded expression in the portion of the prepared input information out of the prompt, that the content C corresponding to the user input information input to the generative model itself is to be generated, and generates the content C corresponding to the embedded expression of the user input information input to the generative model itself.

For example, it is assumed that the remittance source user inputs a message “This is for the last lunch. Thank you.” In this case, as illustrated in FIG. 10, the generative model generates, as the content C, an image of a meal which often appears in the case of the lunch based on an embedded expression of a word “lunch.” Moreover, for example, the generative model may recognize, based on the embedded expression of words “thank you” included in the message, that the message is a message of gratitude, and may generate, as the content C, an image of flowers appropriate as the gratitude. Moreover, for example, the generative model may generate the content C corresponding to the amount of money included in the input information. The generative model may generate the content C indicating a more gorgeous lunch or more gorgeous flowers as the amount of money becomes larger.

Modification Example 2 is different from the at least one embodiment in the flow of the acquisition of the prompt, but the flow of the processing (the flow in which the content generation module 102 acquires the content C generated by the generative model, and the content providing module 103 provides this content C) executed after the generative model generates the content C may be the same as that of the at least one embodiment.

The content providing system 1 according to Modification Example 2 acquires the prompt based on at least one of the user identification information with which at least one of the plurality of users is identifiable, the message to this at least one user, or the substance of the electronic money. As a result, the content providing system 1 can provide appropriate content C corresponding to the user input information to the user. For example, the content providing system 1 can generate the content C corresponding to at least one of the remittance source user or the remittance destination user. The content providing system 1 can generate the content C corresponding to the message to at least one of the remittance source user or the remittance destination user. The content providing system 1 can generate the content C corresponding to the substance of the electronic money.

### 6-3. Modification Example 3

For example, in the at least one embodiment, there has been exemplified the case in which the user input information input on the input screen SC2 is input to the generative model, but information not particularly input on the input screen SC2 may be acquired as the input information. The information other than information input on the input screen SC2 is hereinafter referred to as “non-screen-input information.” The non-screen-input information may not be the information input by the user, but may be information prepared in advance or information acquired on site. For example, the non-screen-input information may be the user basic information, the use history information, the date and time at that moment, the time at that moment, or the season at that moment.

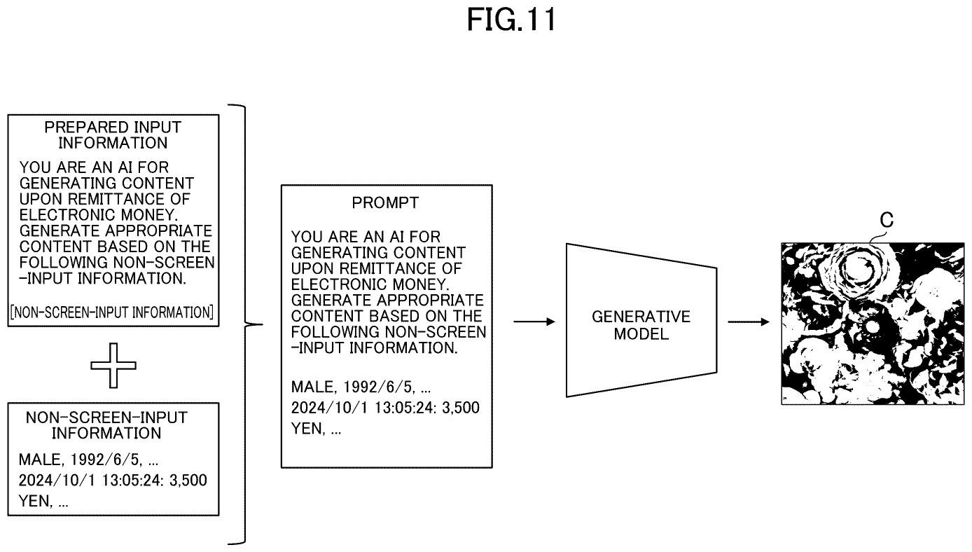

FIG. 11 is a diagram for illustrating an example of input to and output from the generative model in Modification Example 3. The input information acquisition module 101 in Modification Example 3 acquires the non-screen-input information other than information input on the input screen and relating to at least one of the plurality of users, and acquires the prompt based on the non-screen-input information. The input information acquisition module 101 may acquire the non-screen-input information relating to the remittance destination user. For example, the input information acquisition module 101 may acquire, as the non-screen-input information, at least one of the user basic information or the use history information on the remittance destination user. The input information acquisition module 101 may acquire the non-screen-input information relating to the remittance source user. For example, the input information acquisition module 101 may acquire, as the non-screen-input information, at least one of the user basic information or the use history information on the remittance source user.

In Modification Example 3, there is exemplified a case in which the non-screen-input information is stored in the user database DB1. Thus, the input information acquisition module 101 acquires the non-screen-input information from the user database DB1. The non-screen-input information may be stored in another database other than the user database DB1, another computer other than the server 10, or an information storage medium. In this case, the input information acquisition module 101 is only required to acquire the non-screen-input information from the another database, the another computer, or the information storage medium.

In the example of FIG. 11, the prepared input information indicates a text “You are an AI for generating content upon remittance of electronic money. Generate appropriate content based on the following non-screen-input information.” The input information acquisition module 101 in Modification Example 3 may not acquire the user input information, but acquire the prompt based on the prepared input information and the non-screen-input information. That is, in Modification Example 3, the user input information is not required to be acquired. An aspect in which the user input information is not acquired and the non-screen-input information in Modification Example 3 is acquired is also included within the scope of the present disclosure. The content providing system 1 in Modification Example 3 is not required to have the function of acquiring the user input information.

For example, the content generation module 102 inputs the prompt to the generative model in the same manner as in the at least one embodiment. The generative model calculates the embedded expression corresponding to the prompt based on the parameters adjusted through the pre-training, and outputs the content C corresponding to the embedded expression. As illustrated in FIG. 11, when the generation of the content C corresponding to the non-screen-input information is indicated in the prepared input information, the generative model recognizes, through the embedded expression in the portion of the non-screen-input information out of the prompt, that the content C corresponding to the non-screen-input information input to the generative model itself is to be generated, and generates the content C corresponding to the embedded expression of the non-screen-input information input to the generative model itself. For example, when it is indicated in the non-screen-input information that the preference of the remittance destination user is the flower, the generative model generates the content C of flowers as illustrated in FIG. 11.

It is assumed that flowers are indicated as an article purchased in the past by the remittance destination user in the use history information of the remittance destination user. In this case, the generative model recognizes, based on the embedded expression of the use history information, that the flowers are indicated in the use history information, and generates the content C indicating flowers. Moreover, for example, the generative model may generate the content C corresponding to the age or the age group of the remittance destination user indicated in the input information. The generative model may generate the content C corresponding to an address of the remittance destination user indicated in the input information. The generative model may generate the content C corresponding to the season at that moment indicated in the input information.

Modification Example 3 is different from the at least one embodiment in such a point that the non-screen-input information is included in the prompt, but the flow of the processing (the flow in which the content generation module 102 acquires the content C generated by the generative model, and the content providing module 103 provides this content C) executed after the generative model generates the content C may be the same as that of the at least one embodiment.

The content providing system 1 according to Modification Example 3 acquires the non-screen-input information relating to at least one of the plurality of users, and acquires the prompt based on the non-screen-input information. As a result, the content providing system 1 can provide appropriate content C corresponding to the non-screen-input information to the user. For example, the content providing system 1 can generate the content C corresponding to the attribute of at least one of the remittance source user or the remittance destination user. The content providing system 1 can generate the content C corresponding to the history of use of the settlement service by at least one of the remittance source user or the remittance destination user.

### 6-4. Modification Example 4

For example, approval relating to the provision of the content C generated by the generative model may be granted. The content providing system 1 according to Modification Example 4 includes the approval request module 104. The approval request module 104 requests approval relating to the provision of the content C from at least one of the plurality of users. Approval relating to the provision of the content C is approval for the content providing module 103 to provide the content C. Approval may also be referred to as “permission.” The approval request module 104 requests approval by transmitting display data on a screen for receiving approval to the user terminal 20 of at least one of the plurality of users.

The user from whom the approval is requested may be the same user as the user to whom the content C is to be provided, or may be a user to whom the content C is not to be provided. The approval request module 104 may request the approval from all of the plurality of users, or may request the approval from some of the plurality of users. In Modification Example 4, there is exemplified a case in which the approval request module 104 requests the approval from the remittance source user, but the approval request module 104 may request the approval from the remittance destination user. In the user database DB1, setting indicating whether or not each user has granted the approval may be stored. When the user once grants the approval, this setting may subsequently be referred to, and the content C may then be provided.

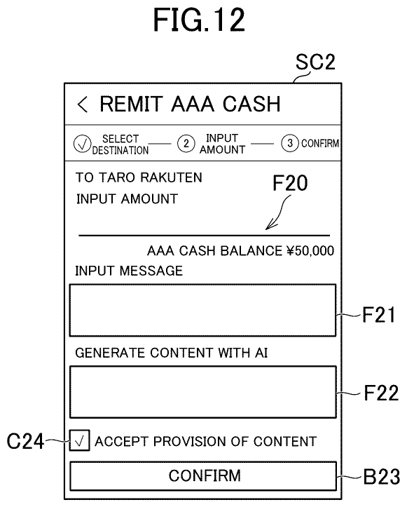

FIG. 12 is a view for illustrating an example of the input screen SC2 in Modification Example 4. In Modification Example 4, there is exemplified a case in which the approval is granted on the input screen SC2, but the approval may be granted on a screen other than the input screen SC2. For example, the approval may be granted on a screen before the display of the input screen SC2, the confirmation screen SC3, a screen displayed after the confirmation screen SC3, or another screen. In the example of FIG. 12, the input screen SC2 includes a checkbox C24 for receiving an operation of granting the approval. The remittance source user checks the checkbox C24, to thereby grant the approval.

For example, when the button B23 is selected, the user terminal 20 transmits to the server 10 data indicating a selection result of the checkbox C24. That is, the user terminal 20 transmits the data indicating whether or not the approval has been granted. The server 10 can identify whether or not the approval has been granted by receiving this data. When the approval has been granted, the content generation module 102 may cause the generative model to generate the content C. That is, the content generation module 102 may cause the generative model to generate the content C under the condition that the approval has been granted. The content generation module 102 may not cause the generative model to generate the content C when the approval has not been granted.

The content providing module 103 according to Modification Example 4 provides the content C generated by the content generation module 102 to at least one of the plurality of users when the approval has been granted. That is, the content providing module 103 provides the content C under the condition that the approval has been granted. The content providing module 103 does not provide the content C when the approval has not been granted. The content C may be generated by the content generation module 102 regardless of whether or not the approval has been granted, and whether or not the content C is to be provided by the content providing module 103 may be controlled based on whether or not the approval has been granted.

The approval may be granted through any operation. The approval is not limited to the operation executed on the checkbox C24. For example, the approval may be granted through an operation executed on another part (part as user interface) other than the checkbox C24. The another part may be a button such as a radio button, a part corresponding to an input form other than a button, a text displayed on the screen, a slide bar, or an icon. It is only required for the server 10 to acquire data indicating a result of one of the above-mentioned any operations from the user terminal 20, to thereby determine whether or not the approval has been granted.

The content providing system 1 according to Modification Example 4 requests the approval relating to the provision of the content C from at least one of the plurality of users. The content providing system 1 provides the content C generated by the content generation module 102 to at least one of the plurality of users when the approval has been granted. As a result, the content providing system 1 can provide the content C when the approval has been granted, and hence can increase the convenience of the user.

### 6-5. Modification Example 5

For example, the input information acquisition module 101 may acquire, as the input information, past settlement information relating to the electronic settlement made in the past in the settlement service, and relating to at least one of the plurality of users. The past settlement information is a history that relates to the settlement out of the use history indicated in the use history information. The past settlement information may indicate a history of the settlement in the entire period in the past or may indicate a history of the settlement in a partial period in the past.

In Modification Example 5, there is exemplified a case in which the past settlement information indicates the settlement made immediately before the current time, but the past settlement information may indicate a history of a plurality of times of settlement. The input information acquisition module 101 acquires, as the past settlement information, the information that indicates the settlement made immediately before the current time out of the use history information stored in the user database DB1. The past settlement information may be stored in another database other than the user database DB1, another computer other than the server 10, or an information storage medium. The input information acquisition module 101 may acquire the past settlement information from the another database, the another computer, or the information storage medium.

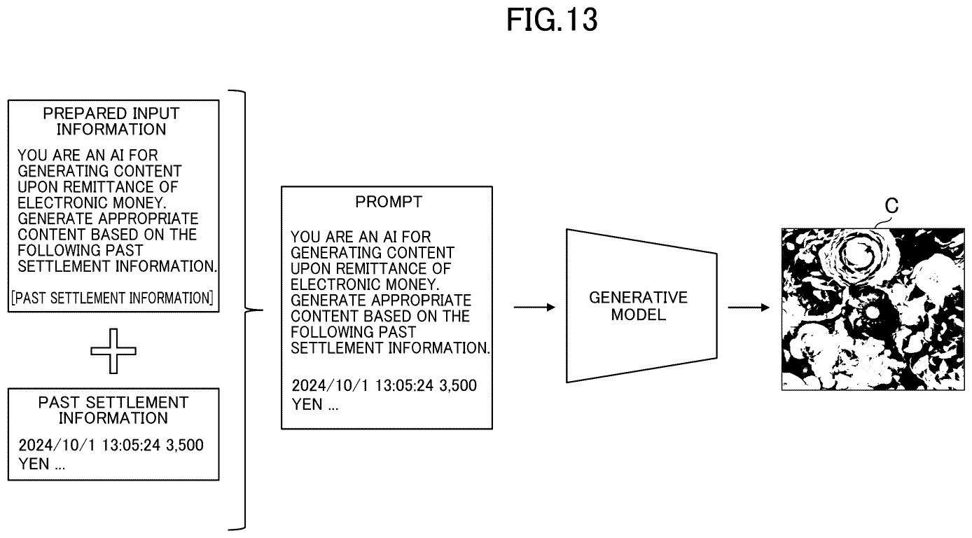

FIG. 13 is a diagram for illustrating an example of input to and output from the generative model in Modification Example 5. In the example of FIG. 13, the input information acquisition module 101 in Modification Example 5 acquires the prompt including the past settlement information. The prepared input information in Modification Example 5 indicates such an instruction to cause the generative model to generate the content C corresponding to the past settlement information. For example, the prepared input information indicates a text “You are an AI for generating content upon remittance of electronic money. Generate appropriate content based on the following past settlement information.”

“[PAST SETTLEMENT INFORMATION]” of FIG. 13 is a tag which indicates a position at which the past settlement information is to be set. Thus, the input information acquisition module 101 sets the past settlement information at a portion of the prepared input information that is indicated by the tag, to thereby acquire a final prompt. The setting of the past settlement information means the insertion of the past settlement information. The past settlement information may not be built into the prepared input information, but may be input to the generative model independently of the prepared input information. The input information acquisition module 101 may not acquire the prepared input information, but may acquire the past settlement information directly as the prompt.

The content generation module 102 in Modification Example 5 causes the generative model to generate the content C based on the past settlement information. For example, the content generation module 102 inputs the prompt to the generative model in the same manner as in the at least one embodiment. The generative model calculates the embedded expression corresponding to the prompt based on the parameters adjusted through the pre-training, and outputs the content C corresponding to the embedded expression. As illustrated in FIG. 13, when the generation of the content C corresponding to the past settlement information is indicated in the prepared input information, the generative model recognizes, through the embedded expression in the portion of the past settlement information out of the prompt, that the content C corresponding to the past settlement information input to the generative model itself is to be generated, and generates the content C corresponding to the embedded expression of the past settlement information input to the generative model itself. In the example of FIG. 13, purchase of flowers is indicated in the past settlement information, and hence the generative model generates the content C of the flowers indicated by the past settlement information.

Modification Example 5 is different from the at least one embodiment in such a point that the past settlement information is included in the prompt, but the flow of the processing (the flow in which the content generation module 102 acquires the content C generated by the generative model, and the content providing module 103 provides this content C) executed after the generative model generates the content C may be the same as that of the at least one embodiment.

The content providing system 1 in Modification Example 5 acquires, as the input information, the past settlement information on at least one of the plurality of users. The content providing system 1 causes the generative model to generate the content C based on the past settlement information. As a result, the content providing system 1 can provide appropriate content C corresponding to the past settlement information to the user. For example, the content providing system 1 can provide the content C corresponding to a substance of the settlement made immediately before the current time by the remittance source user or the remittance destination user.

### 6-6. Modification Example 6

For example, the generation of the content C by the generative model may take more or less time. The flow of FIG. 2 is taken as an example, and it is assumed that the generative model generates the content C in a period from the input of the required items by the remittance source user on the input screen SC2 to the display of the confirmation screen SC3. In this case, when the generation of the content C takes a long time, the display of the confirmation screen SC3 takes a long time accordingly, and hence the remittance source user sometimes feels a sense of discomfort. Thus, in Modification Example 6, there is exemplified a case in which the content providing system 1 generates the content C in advance, to thereby reduce the time required to display the confirmation screen SC3.

The input information acquisition module 101 in Modification Example 6 acquires the input information before any one of the plurality of users executes a predetermined operation for the remittance of or the request for the electronic money. The predetermined operation is an operation being a condition for the remittance of or the request for the electronic money. The predetermined operation is only required to be an operation defined in advance. There is exemplified a case in which the input screen SC2 in Modification Example 6 does not include the input form F22. The remittance source user does not input the user input information on the input screen SC2. The remittance source user may input the user input information before the input screen SC2 is displayed.

For example, the predetermined operation may be an operation of the remittance source user inputting the required items for the remittance of the electronic money (for example, the user identification information on the remittance destination user, the amount of money, the message, the substance of the content C, or a combination thereof) or an operation (for example, the selection of the button B23) executed thereafter. The predetermined operation may be an operation of the remittance destination user inputting the required items for the request for the electronic money (for example, the user identification information on the remittance source user, the amount of money, the message, the substance of the content C, or a combination thereof) or an operation executed thereafter.

For example, the input information acquisition module 101 acquires the input information when a predetermined condition is satisfied. The predetermined condition is a condition serving as a trigger for the input information acquisition module 101 to acquire the input information. For example, the predetermined condition may be such a condition that the settlement app starts, predetermined date and time are reached, the remittance function of the settlement app is selected, an operation (for example, the selection of the button B10) for the display of the input screen SC2 is executed, the user approves the generation of the content through use of the AI (for example, the user turning on, when the function of generating the content through use of the AI can be turned on or off, this function), another operation is executed, or the remittance reaches a predetermined amount of money or a predetermined number of times. The input information in Modification Example 6 may be any input information described in any one of the at least one embodiment and Modification Examples 1 to 5.

In Modification Example 6, there is exemplified a case in which a predetermined time arriving every day corresponds to the predetermined condition. Moreover, there is exemplified a case in which the use history information on the remittance source user corresponds to the input information. For example, the input information acquisition module 101 uses publicly-known means such as a real-time clock or the GPS to identify the current date and time and then determines whether or not the time corresponding to the predetermined condition has been reached, to thereby determine whether or not the predetermined condition is satisfied. The input information acquisition module 101 does not acquire the input information when the predetermined condition is not determined to be satisfied. The input information acquisition module 101 acquires the input information when the predetermined condition is determined to be satisfied. For example, the input information acquisition module 101 acquires, as the input information, the use history information on each of the plurality of users from the user database DB1.

The content generation module 102 in Modification Example 6 causes the generative model to generate the content C before any one of the plurality of users executes the predetermined operation. When the predetermined condition is satisfied, the content generation module 102 inputs, for each user, the input information acquired for the content C of this user to the generative model to cause the generative model to generate the content C for this user. The content generation module 102 stores, for each user, the content C for this user in the user database DB1 in association with the user ID and the login account of this user.

The content providing module 103 in Modification Example 6 provides, after any one of the plurality of users executes the predetermined operation, the content C generated by the content generation module 102 to at least one of the plurality of users. When a certain user remits or requests the electronic money, the content providing module 103 acquires the content C for this user stored in the user database DB1. Modification Example 6 is different from the at least one embodiment and Modification Examples 1 to 5 in the point that the content providing module 103 provides the content C generated in advance, but is the same as the at least one embodiment and Modification Examples 1 to 5 in processing for providing the content C.

The content providing system 1 according to Modification Example 6 acquires the input information before any one of the plurality of users executes the predetermined operation for the remittance of or the request for the electronic money. The content providing system 1 causes the generative model to generate the content C before any one of the plurality of users executes the predetermined operation. The content providing system 1 provides the content C generated by the content generation module 102 to at least one of the plurality of users after the any one of the plurality of users executes the predetermined operation. As a result, the content providing system 1 can reduce the time required to provide the content C. For example, the content providing system 1 can reduce the time from the remittance source user finishing the input to the input screen SC2 to the display of the confirmation screen SC3.

### 6-7. Modification Example 7

For example, the content generation module 102 may cause the generative model to generate a plurality of pieces of content C. The number of pieces of content C generated by the generative model may be input to the generative model as the prompt, may be defined in advance in the program of the generative model, or may be specified as the setting for the generative model. The number of pieces of content C to be generated by the generative model may be any number. For example, the number of pieces of content C to be generated by the generative model may be a certain specific number (for example, 2, 3, or a predetermined number of 4 or more) or in a certain numerical value range (for example, a range of from 2 to 5).

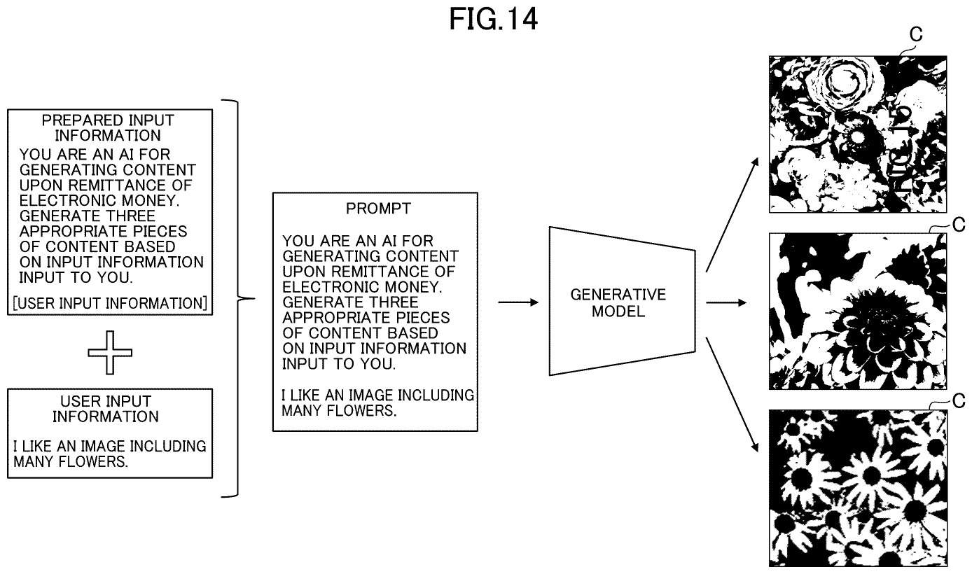

FIG. 14 is a diagram for illustrating an example of input to and output from the generative model in Modification Example 7. In Modification Example 7, there is exemplified a case in which the number of pieces of content C to be generated by the generative model is indicated in the prepared input information, and is input as the prompt to the generative model. For example, the prepared input information indicates the number of pieces of content C to be generated by the generative model such that “You are an AI for generating content upon remittance of electronic money. Generate three appropriate pieces of content based on the input information input to you.” The input information acquisition module 101 in Modification Example 7 acquires, as the input information, a prompt including the prepared input information indicating the number of pieces of content C to be generated by the generative model.

The content generation module 102 in Modification Example 7 inputs the prompt indicating the number of pieces of content C to be generated by the generative model to the generative model. The generative model calculates the embedded expression corresponding to the prompt based on the parameters adjusted through the pre-training, and outputs the content C corresponding to the embedded expression. As illustrated in FIG. 14, when the number of pieces of content C to be generated by the generative model is indicated in the prepared input information, the generative model recognizes, through the embedded expression in the portion of the prompt that indicates the number of pieces of content C indicated by the prepared input information, the number of pieces of content C to be generated by the generative model itself, and generates as many pieces of content C as this number based on the embedded expression in another portion.

The number of pieces of content C to be generated by the generative model may be a fixed number defined in advance, or may be specifiable by the user. For example, input of the number of pieces of content C to be generated by the generative model may be received on the input screen SC2. In this case, the user input information indicates the number of pieces of content C to be generated by the generative model. The number of pieces of content C may be input to the input form F22, or the number of pieces of content C may be input on a pulldown menu other than the input form F22.

The content providing module 103 in Modification Example 7 provides, to at least one of the plurality users, a piece of content C selected by this at least one user or another user from the plurality of pieces of content C. For example, the plurality of pieces of content C generated as illustrated in FIG. 14 are displayed on the confirmation screen SC3 or another screen as candidates of the content C to be finally provided. The remittance source user selects any one of the plurality of pieces of content C. The content providing module 103 provides the confirmation screen SC3 including the content C selected by the remittance source user to the remittance source user. The content providing module 103 provides the reception screen SC4 including the content C selected by the remittance source user to the remittance destination user. Moreover, for example, the plurality of pieces of content C generated as illustrated in FIG. 14 may be displayed on the confirmation screen SC3 or another screen as the candidates of the content C to be finally provided. After that, the electronic money is remitted from the remittance source user to the remittance destination user. Before the remittance destination user displays the reception screen SC4 for receiving the electronic money, the remittance destination user may select any one of the plurality of pieces of content C. The content providing module 103 may provide, to the remittance destination user, the reception screen SC4 including the content C selected by the remittance destination user.

The content providing system 1 according to Modification Example 7 causes the generative model to generate the plurality of pieces of content C. The content providing system 1 provides, to at least one of the plurality users, a piece of content C selected from the plurality of pieces of content C by this at least one user or another user. As a result, the content providing system 1 can provide more appropriate content C.

### 6-8. Modification Example 8

For example, in the at least one embodiment, there has been exemplified the case in which the general-purpose generative AI also capable of generating another piece of content C other than the content C in the settlement service is used as the generative model. In Modification Example 8, there is exemplified a case in which a model trained through use of training data specific to the settlement service corresponds to the generative model. That is, the generative model in Modification Example 8 is a dedicated model specialized in the generation of the content C in the settlement service. In Modification Example 8, there is exemplified a case in which the generative model before being trained is stored in the data storage unit 100. The generative model before being trained is a model having initial values as the parameters. The generative model before being trained may be a model which has been pre-trained to a certain degree. The model before being trained may be stored in the external system 2.

The content providing system 1 according to Modification Example 8 includes the training module 105. The training module 105 causes the generative model to learn training data relating to the relationship between training input information being input information for training and content for training corresponding to this training input information. The training data is data to be learned by the generative model. The training data is a pair of the training input information and the content for training. In Modification Example 8, there is exemplified a case in which a plurality of pieces of training data are stored in a training database DB2, but the plurality of pieces of training data may be stored in another database other than the training database DB2, another computer other than the server 10, or an information storage medium. The training module 105 is only required to acquire the training data from the training database DB2, the another database, the another computer, or the information storage medium. The training data is prepared by an administrator of the content providing system 1.

The training input information is information which is input to the generative model at the time of training. The training input information has the same format as that of the input information which is input to the generative model at the time of estimation. In Modification Example 8, there is exemplified a case in which the training input information includes the user basic information for training and the use history information for training. Only one of the user basic information for training and the use history information for training may correspond to the training input information. The training input information may be another piece of information which has been described as an example of input information in any one of the at least one embodiment and Modification Examples 1 to 7, and which is prepared for training. The content for training is content C being ground truth at the time of training. In other words, the content for training is the content C the generation of which by the generative model is desired when the training input information is input.

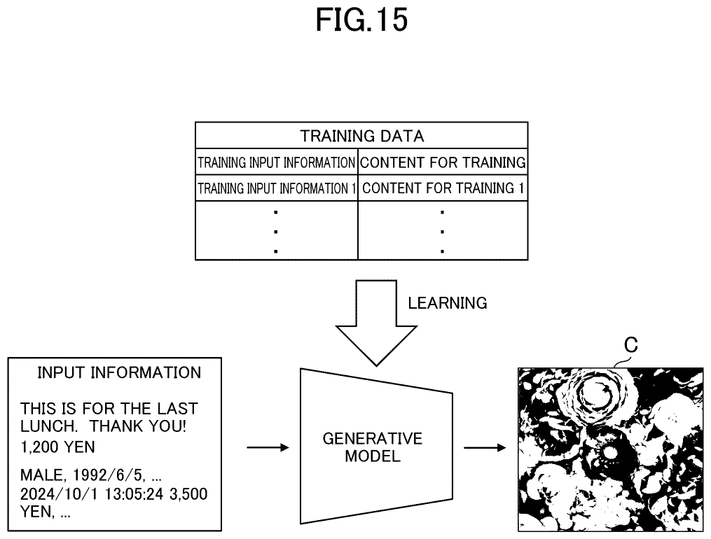

FIG. 15 is a diagram for illustrating an example of input to and output from the generative model in Modification Example 8. In FIG. 15, an example of the training data is also illustrated. The training module 105 executes, based on the training data, the training of the generative model. The training module 105 adjusts the parameters of the generative model such that the generative model generates the content for training when the training input information is input to the generative model. As the training itself, a publicly-known training method can be used. For example, the training module 105 may execute the training of the generative model based on error back propagation or gradient descent. The training module 105 may repeat the training of the generative model based on the training data until a loss calculated through a predetermined loss function becomes small to a certain degree. The training module 105 overwrites and stores the generative model stored in the data storage unit 100 when the training is completed.

The content generation module 102 in Modification Example 8 causes the generative model trained by the training module 105 to generate the content C. Modification Example 8 is different from the at least one embodiment and Modification Examples 1 to 7 in the point that the training is executed by the training module 105, but is the same as the at least one embodiment and Modification Examples 1 to 7 in a flow of the generation of the content C. In the example of FIG. 15, the content generation module 102 inputs the user basic information and the use history information on at least one of the remittance source user or the remittance destination user to the generative model as the input information. The generative model calculates the embedded expression of the input information based on the parameters adjusted by the training module 105, and outputs the content C corresponding to the embedded expression. Modification Example 8 is the same as the at least one embodiment and Modification Examples 1 to 7 also in the flow in which the content C generated by the content generation module 102 is provided by the content providing module 103.

The content providing system 1 according to Modification Example 8 causes the generative model to learn the training data relating to the relationship between the training input information being the input information for training and the content for training corresponding to this training input information. The content providing system 1 causes the generative model trained by the training module 105 to generate the content C. As a result, the content providing system 1 can create the generative model capable of generating the content C specific to the settlement service, and hence can increase accuracy of the content C.

### 6-9. Other Modification Examples

For example, the modification examples described above may be combined with one another.

For example, the functions described as being implemented by the server 10 may be implemented by the user terminal 20 or another computer. The function described as being implemented by the server 10 may be implemented by a plurality of computers in a distributed manner.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A content providing system, comprising at least one processor configured to:
acquire input information which is input to a generative model configured to generate content to be provided in a service in which a monetarily valuable item is transmitted among a plurality of users;
cause the generative model to generate the content based on the input information; and
provide the content to at least one of the plurality of users.

2. The content providing system according to claim 1,
wherein the generative model is a model of a generative artificial intelligence (AI) configured to generate the content, and
wherein the at least one processor is configured to:
acquire, as the input information, a prompt for instructing the generative model to generate the content; and
cause the generative model to generate the content based on the prompt.

3. The content providing system according to claim 2, wherein the at least one processor is configured to acquire user input information relating to input received on an input screen for any one of the plurality of users to transmit or request the monetarily valuable item, and acquire the prompt based on the user input information.

4. The content providing system according to claim 3, wherein the at least one processor is configured to acquire the user input information indicating a substance of the content that is input on the input screen by any one of the plurality of users.

5. The content providing system according to claim 2, wherein the at least one processor is configured to acquire prepared input information relating to input and prepared in advance, and acquire the prompt based on the prepared input information.

6. The content providing system according to claim 5, wherein the at least one processor is configured to acquire the prepared input information indicating that the generative model generates the content corresponding to user input information relating to input received on an input screen for any one of the plurality of users to transmit or request the monetarily valuable item.

7. The content providing system according to claim 5, wherein the at least one processor is configured to acquire the prepared input information indicating that the generative model generates the content corresponding to past content generated in a past by the generative model.

8. The content providing system according to claim 2, wherein the at least one processor is configured to acquire the prompt based on at least one of user identification information with which at least one of the plurality of users is identifiable, a message to the at least one of the plurality of users, or a substance relating to the monetarily valuable item.

9. The content providing system according to claim 2, wherein the at least one processor is configured to acquire non-screen-input information other than information input on the input screen and relating to at least one of the plurality of users, and acquire the prompt based on the non-screen-input information.

10. The content providing system according to claim 1, wherein the at least one processor is configured to:
request approval relating to provision of the content from at least one of the plurality of users; and
provide the content to the at least one of the plurality of users when the approval is granted.

11. The content providing system according to claim 1,
wherein the service is a settlement service that provides an electronic settlement to each of the plurality of users, and
wherein the at least one processor is configured to:
acquire, as the input information, past settlement information relating to the electronic settlement made in a past in the settlement service, and relating to at least one of the plurality of users; and
cause the generative model to generate the content based on the past settlement information.

12. The content providing system according to claim 1, wherein the at least one processor is configured to:
acquire the input information before any one of the plurality of users executes a predetermined operation for transmitting or requesting the monetarily valuable item;
cause the generative model to generate the content before the any one of the plurality of users executes the predetermined operation; and
provide the content to at least one of the plurality of users after the any one of the plurality of users executes the predetermined operation.

13. The content providing system according to claim 1, wherein the at least one processor is configured to:
cause the generative model to generate a plurality of pieces of the content; and
provide, to at least one of the plurality of users, a piece of content selected from the plurality of pieces of the content by any one of the at least one of the plurality of users or another user.

14. The content providing system according to claim 1, wherein the at least one processor is configured to:
cause the generative model to learn training data relating to a relationship between training input information being the input information for training and content for training corresponding to the training input information; and
cause the trained generative model to generate the content.

15. A content providing method, comprising:
acquiring input information which is input to a generative model configured to generate content to be provided in a service in which a monetarily valuable item is transmitted among a plurality of users;
causing the generative model to generate the content based on the input information; and
providing the content generated in the causing the generative model to generate the content, to at least one of the plurality of users.

16. A non-transitory information storage medium having stored thereon a program for causing a computer to:
acquire input information which is input to a generative model configured to generate content to be provided in a service in which a monetarily valuable item is transmitted among a plurality of users;
cause the generative model to generate the content based on the input information; and
provide the content to at least one of the plurality of users.
